(19) United States
(12) Patent Application Publication
(10) Pub. No.: US 2011/0151824 A1
(43) Pub. Date: Jun. 23, 2011

(54) WIRELESS COMMUNICATION DEVICE AND METHOD FOR SAVING ENERGY

(75) Inventor: LUNG DAI, Tu-Cheng (TW)

(73) Assignee: HON HAI PRECISION INDUSTRY CO., LTD., Tu-Cheng (TW)

(21) Appl. No.: 12/958,451

(22) Filed: Dec. 2, 2010

(30) Foreign Application Priority Data
Dec. 18, 2009 (CN) 200910311808.0

(51) Int. Cl. H04B 1/06

(52) U.S. Cl. 455/352

(57) ABSTRACT

An energy saving method applied to a wireless communication, the wireless communication comprising a RF unit to search for wireless network signals, the method includes steps of: detecting whether the RF unit finds the wireless network signals; counting a length of time the RF unit does not find the wireless network if the RF unit does not find the wireless network signals; determining whether the length of time the RF unit does not find the wireless network reaches a predetermined search time limit; and turning off the RF unit if the length of time the RF unit dose not find the wireless network reaches the predetermined search time limit limit.

### BACKGROUND

1. Technical Field

The present disclosure relates to wireless communication devices, and particularly to a wireless communication device and an energy saving method.

2. Description of Related Art

Wireless communication devices, such as mobile phones and personal digital assistants (PDAs), use a tuner to search for wireless networks, and the tuner emits high frequency electromagnetic waves during the search.

However, when the typical wireless communication device is turned on, the tuner begins to search and continues to search for the corresponding wireless network even if it does not receive any wireless network signals. This not only consumes a lot of electric power, but also generates a lot of electromagnetic wave to affect people's health.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments.

Moreover, in the drawings, like reference numerals designate corresponding parts throughout the several views.

FIG. 1 is a block function diagram of a wireless communication device in accordance with an exemplary embodiment.

FIG. 2 is a flow chart of a method for saving energy in accordance with a first exemplary embodiment.

FIG. 3 is a flow chart of a method for saving energy in accordance with a second exemplary embodiment.

### DETAILED DESCRIPTION

The present discloser provides an electronic device with a displaying method, a display of the electronic can be turned off only when the display is not needed, which is convenient for a user.

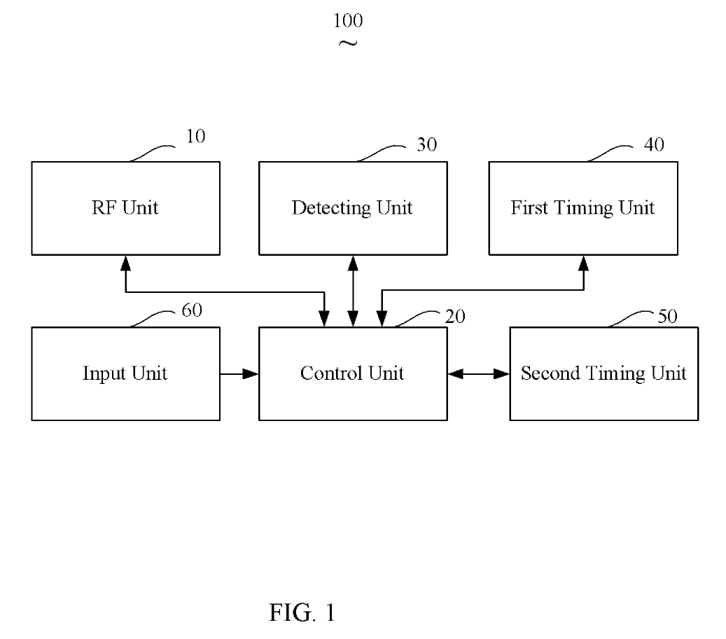

Referring to FIG. 1, a function diagram of a wireless communication device 100 is shown. The wireless communication device 100 is capable of accessing wireless networks, such as global system for mobile communications (GSM), code division multiple access (CDMA), time division synchronous code division multiple access (TD-SCDMA), and so on. The wireless communication device 100 may be a mobile phone, a PDA, or other devices having a wireless communication function.

The wireless communication device 100 includes a radio frequency (RF) unit 10, a control unit 20, a detection unit 30, a first timing unit 40, and a second timing unit 50. The RF unit 10, such as a tuner, is configured to search for wireless network signals.

The control unit 20 is configured to control the RF unit 10 to work. For example, when the wireless communication device 100 is turned on, the control unit 20 generates a start signal to control the RF unit 10 to turn on to search for the wireless network signals.

The detection unit 30 is configured to detect whether the RF unit 10 finds wireless network signals, generate a first timing signal if the RF unit 10 does not find wireless network signals, and generate a stop timing signal if the RF unit 10 finds wireless network signals

The first timing unit 40 is configured to begin to count a time in response to the first timing signal, and configured to stop counting the time in response to the stop timing signal, thus a length of time the RF unit 10 does not find the wireless network signals can be counted. The first timing unit 40 is further configured to generate an off signal when the length of time the RF unit 10 does not find the wireless network signals reaches a predetermined search time limit. The predetermined search time limit can be set according to user requirements. In this embodiment, the predetermined search time limit is 3 minutes.

The control unit 20 is further configured to turn off the RF unit 10 and generate a second timing signal in response to the off signal.

The second timing unit 50 is configured to count the length of time the RF unit 10 is turned off. The second timing unit 50 is further configured to generate the start signal to control the RF unit 10 to search for the wireless network signals when the length of time the RF unit 10 is turned off reaches a predetermined off time limit. The predetermined off time limit can be set according to user requirements. In this embodiment, the predetermined off time limit is 5 minutes.

Furthermore, the wireless communication device 100 further includes an input unit 60. The input unit 60 is an entity button located on the wireless communication device 100, or a soft key displayed on a screen (not shown) of the wireless communication device 100. The input unit 60 is configured to generate the start signal or the off signal to control the RF unit 10 to turn on or turn off in response to user operations. For example, when the RF unit 10 is turned on, the user clicks the input unit 60, and the input unit 60 will generate the off signal in response to the click action. When the RF unit 10 is turned off, the user can click the input unit 60, and the input unit 60 will generate the start signal in response to the click action. In other words, the user can determine when to turn off or turn on the RF unit 10. For example, if the user stays in a region without the wireless networks for a long time, the user can turn off the RF unit 10 and the RF unit 10 will not automatically periodically turn on and search for the wireless networks, thus, the power is saved and the less high frequency electromagnetic waves are emitted, which is considered by some to be healthier for people.

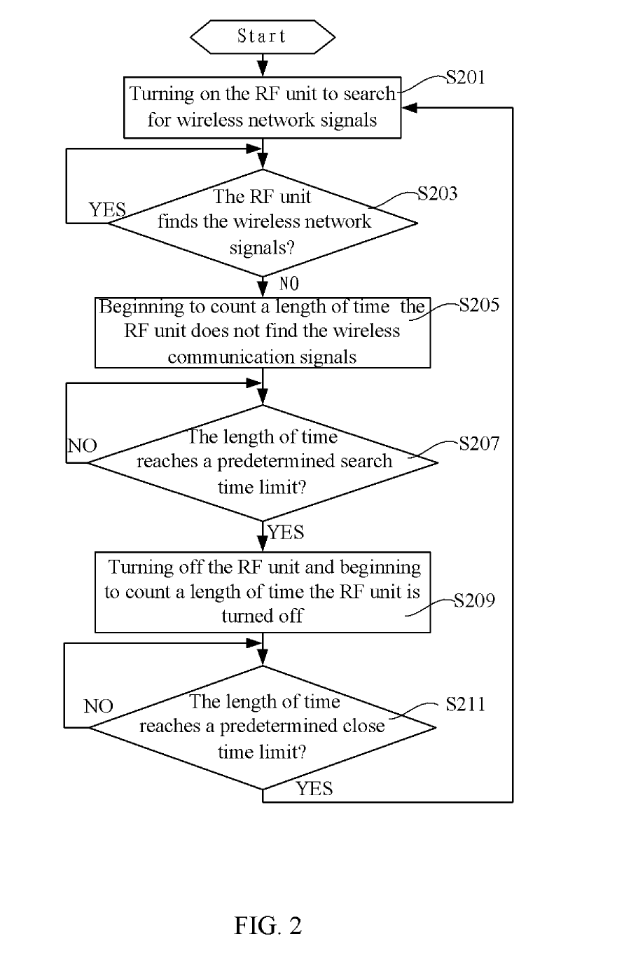

Referring to FIG. 2, an energy saving method applied to a wireless communication device is shown. The wireless communication device includes an RF unit for searching for wireless network signals. The method includes the following steps.

In step S201, turning on the RF unit to search for wireless network signals. For example, when wireless communication device is turned on, the RF unit is turned on.

In step S203, detecting whether the RF unit finds the wireless network signals.

In step S205, beginning to count a length of time the RF unit does not find the wireless network signals if the RF unit does not find the wireless network signals.

In step S207, determining whether the length of time the RF unit does not find the wireless communication signals reaches a predetermined search time limit. The predetermined search time limit can be set according to user requirements. For example, the predetermined search time limit can be set as 3 minutes.

In step S209, turning off the RF unit and beginning to count a length of time the RF unit is turned off if the length of time the RF unit does not find the wireless communication signals reaches the predetermined search time limit.

In step S211, determining whether the length of time the RF unit is turned off reaches a predetermined off time limit, jumps to step S201 to turn on the RF unit to search for wireless network signals. The predetermined off time limit can be set according to user's requirements. For example, predetermined off time limit can be set as 5 minutes.

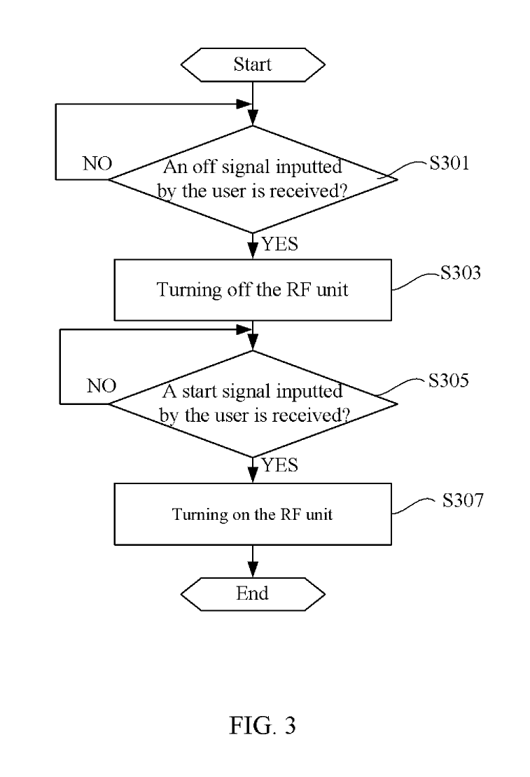

Referring to FIG. 3, furthermore, the saving energy further includes the following steps. Please note that step S303 is ongoing while the previous steps S201-S207 are performed.

And if step S303 occurs at any time during steps S201-S207, steps S201-S207 will be interrupted and the flow goes to S305.

In step S303, detecting whether an off signal input by the user is received. For example, the off signal can be input by setting an input unit of the wireless communication device, and clicking the input unit by user when the RF unit is turned on. The input unit may be an entity button or a soft button.

In step S305, turning off the RF unit if the off signal is received.

In step S307, detecting whether a start signal input by the user is received. For example, user can input the start signal by clicking the input unit when the RF is turned off.

In step S309, turning on the RF unit if the start signal is received.

As describe above, the wireless communication device and the method of saving energy can turn off the RF unit when the RF unit does not find wireless network signals for a predetermined time. Thus, the wireless communication can save electric power and generates less the electromagnetic wave. Furthermore, the user can determine when to turn off and turn on the RF unit 10, thus the wireless communication device is more humanism.

What is claimed is:

1. A wireless communication device comprising:
a radio frequency (RF) unit to search wireless network signals;
a detecting unit to detect whether the RF unit finds the wireless network signals and generate a first timing signal if the RF unit does not find the wireless network signals;
a first timing unit begin to count a length of time the RF unit does not find the wireless network signals in response to the first timing signal, and generate an off signal when the length of time the RF unit does not find the wireless network signals reached a predetermined search time limit; and
a control unit to control the RF unit to turn off in response to the off signal.

2. The wireless communication device of claim 1, further comprising a second timing unit, the control unit further begin to count a length of time the RF unit is turned off, and generate the start signal to control the RF unit to turn on if the length of time the RF unit is turn off reaches a predetermined off time limit.

3. The wireless communication device of claim 1, further comprising an input unit, the input unit generating an off signal in response to a user operation if the RF is turned on.

4. The wireless communication device of claim 1, further comprising an input unit, the input unit generating a start signal in response to a user operation if the RF is turned off.

5. The wireless communication device of claim 1, wherein the detecting unit further generates a stop timing signal when the RF unit finds the wireless network signals during the first timing unit counting, the first timing unit stops counting in response to the stop timing signal.

6. An energy saving method applied to a wireless communication, the wireless communication comprising a RF unit to search for wireless network signals, the energy saving method comprising:
detecting whether the RF unit finds the wireless network signals;
counting a length of time the RF unit does not find the wireless network if the RF unit does not find the wireless network signals;
determining whether the length of time the RF unit does not receive the wireless network reaches a predetermined search time limit; and
turning off the RF unit if the length of time the RF unit does not find the wireless network reaches the predetermined search time limit.

7. The energy saving method of claim 6, wherein after the step of turning off the RF unit, the energy saving method further comprises:
counting a length of time the RF unit is turned off;
determined whether the length of time the RF unit is turned off reaches a predetermined off time limit; and
turning on the RF unit if the length of time the RF unit is turned off reaches the predetermined off time limit.

8. The energy saving method of claim 7, wherein before the step of turning off the RF unit, the energy saving method further comprises:
determining whether an off signal inputted by a user is received by the wireless communication device; and
turning off the RF unit if the off signal is received by the wireless communication device.

9. The energy saving method of claim 7, wherein after the step of turning off the RF unit, the energy saving method further comprises:
determining whether a start signal inputted by a user is received by the wireless communication device; and
turning on the RF unit if the start signal is received by the wireless communication device.

10. An energy saving method applied to a wireless communication, the wireless communication comprising a RF unit to search for wireless network signals, the method comprising:
determining whether an off signal inputted by a user is received by the wireless communication device; and
turning off the RF unit if the off signal is received by the wireless communication device.

11. The energy saving method of claim 10, wherein after the RF unit is turned off, the method further comprises:
determining whether a start signal inputted by the user is received by the wireless communication device; and
turning on the RF unit if the start signal is received by the wireless communication device.
